(19) United States
(12) Patent Application Publication
(10) Pub. No.: US 2025/0321193 A1
(43) Pub. Date: Oct. 16, 2025

(54) Photonic Crystal-Based Colorimetric Volatile Compound Sensors

(71) Applicant: The Trustees of the University of Pennsylvania, Philadelphia, PA (US)

(72) Inventors: Shu Yang, Blue Bell, PA (US); So Hee Nah, Philadelphia, PA (US); Jong Bin Kim, Philadelphia, PA (US); Hiu Ning Tiffany Chui, Philadelphia, PA (US)

(21) Appl. No.: 19/175,002

(22) Filed: Apr. 10, 2025

Related U.S. Application Data
(60) Provisional application No. 63/632,923, filed on Apr. 11, 2024.

(51) Int. Cl. G01N 21/78; G01N 21/77

(52) U.S. Cl. CPC G01N 21/78; G01N 2021/7769

(57) ABSTRACT

A colorimetric component, comprising: a first photonic crystal, the first photonic crystal having a reflectance spectrum having a stopband in the range of visible light; and a first dye, the first dye being sensitive to a volatile compound, the volatile compound comprising at least one of a volatile organic compound (VOC) and a volatile sulfur compound (VSC), the first dye characterized as undergoing a change in molecular structure when contacted to the volatile compound, and the first photonic crystal and the first dye being selected such that the colorimetric component exhibits a change in visible color when contacted with the volatile compound.

### RELATED APPLICATIONS

The present application claims priority to and the benefit of U.S. patent application No. 63/632,923, “Photonic Crystal-Based Colorimetric Volatile Compound Sensors,” filed Apr. 11, 2024. All foregoing applications are incorporated herein by reference in their entireties for any and all purposes.

### TECHNICAL FIELD

The present disclosure relates to the field of photonic crystals and to the field of colorimetric sensors.

### BACKGROUND

Volatile organic compounds (VOCs) are organic chemicals with high vapor pressures at room temperature, causing them to easily evaporate into the atmosphere. They can originate from various sources, including environmental exposure such as smoking, cooking, and paints, and metabolic processes within the cells. In the case of environmental exposure, VOCs can include harmful compounds that pose health risks when present in high concentrations, making their detection crucial to limit hazard exposure and monitor air quality. VOCs produced from metabolic processes may not be necessarily harmful themselves, but their presence can provide useful information, enabling users to take appropriate action.

Various methods have been developed for detecting VOCs, including photoionization detectors (PIDs), chemiresistive sensors, electrochemical sensors, and optical sensors. PID ionizes gas molecules by using high-energy photons and reads the resulting electrical signal. However, it suffers from intrinsically poor selectivity. The chemiresistive method detects changes in conductivity by trapping electrons on the surface of metal oxides in response to VOCs. Similarly, the electrochemical method reads changes in current resulting from oxidation/reduction reactions caused by VOCs using metal nanoparticles or carbon-based conducting materials. However, these methods often incorporate heaters (150-300° C.) to enhance reaction rates and are often susceptible to environmental interference such as humidity and oxygen. They also require complex fabrication processes to include multiple sensing elements in one array due to their intrinsically low sensor data dimensionality. To enhance selectivity, the use of physical diffusion barriers or surface functionalization is often necessary, which further adds complexity to the sensor.

Optical methods include non-dispersive infrared spectroscopy, which reads the VOCs' molecular absorption of characteristic wavelengths in the infrared range, and UV-vis spectrophotometry, which reads changes in optically-active organic thin films (e.g., zinc phthalocyanine) after exposure to VOCs. Surface acoustic wave (SAW) sensors detect changes of sound waves that propagate through the surface of a piezoelectric crystal (e.g., quartz) after exposure to VOCs. These methods typically exhibit high sensitivity when using high resolution spectroscopy but may not be selective in sensing a specific VOC. It is also difficult to miniaturize the devices. Accordingly, there is a long-felt need in the field for colorimetric sensor devices, in particular devices useful in detecting and distinguishing among VOCs.

### SUMMARY

In meeting the described long-felt needs, the present disclosure provides a colorimetric component, comprising: a first photonic crystal, the first photonic crystal having a reflectance spectrum having a stopband in the range of visible light; and a first dye, the first dye being sensitive to a volatile compound, the volatile compound comprising at least one of a volatile organic compound (VOC) and a volatile sulfur compound (VSC), the first dye characterized as undergoing a change in molecular structure when contacted to the volatile compound, and the first photonic crystal and the first dye being selected such that the colorimetric component exhibits a change in visible color when contacted with the volatile compound.

Also provided is a method, comprising contacting a colorimetric component according to the present disclosure to a volatile compound.

Further provided is a colorimetric component, comprising: n sections, an nth section of the n sections comprising a combination of a photonic crystal and a dye, the nth section exhibiting a change in color when contacted with a volatile compound, the volatile compound comprising at least one of a volatile organic compound (VOC) and a volatile sulfur compound (VSC), the n sections being arranged such that the colorimetric component exhibits a characteristic pattern when contacted with the volatile compound, the characteristic pattern correlated to at least one of (i) the volatile compound and (ii) a concentration of the volatile compound.

Additionally provided is a colorimetric component, comprising: a first section, the first section comprising a first photonic crystal, and the first section comprising a first subsection that comprises a first volatile compound-sensitive dye and a second subsection that comprises a second volatile compound-sensitive dye; and a second section, the second section comprising a second photonic crystal and the second section comprising a first subsection that comprises the first volatile compound-sensitive dye and a second subsection that comprises the second volatile compound-sensitive dye, the first and second sections being arranged such that the colorimetric component exhibits a characteristic pattern when contacted with a volatile compound, the characteristic pattern correlated to at least one of (i) the volatile compound and (ii) a concentration of the volatile compound.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1C. (FIG. 1A) Fabrication process of cPhC and casting of dye on cPhC to create dye-cPhC colorimetric sensor array. (FIG. 1B) Comparison images of dye-cPhC and dye-paper before and after exposure to VOCs. The leftmost column indicates the type of cPhCs used. Dye 1-2 was applied in the samples of the 1^{st} and 4^{th} rows, exposed to acetaldehyde at 5 ppm. Dye 4-2 was used in the 2^{nd} row, exposed to acetic acid at 0.1 ppm. Dye 3-2 was used in the 3^{rd} row, exposed to acetone at 0.5 ppm. Dye 2-2 was used in the 5^{th} row, exposed to acetaldehyde at 5 ppm. (FIG. 1C) Schematic of dye-cPhC's reflectance spectrum before and after VOC exposure. The presence of cPhC underneath enhances the spectral changes, leading to enhanced color change.

FIGS. 2A-2E. SEM image of synthesized monodisperse silica particles with diameter of D. (FIG. 2A) D=218 nm, (FIG. 2B) D=285 nm, (FIG. 2C) D=308 nm, (FIG. 2D) D=346 nm, and (FIG. 2E) D=394 nm.

FIGS. 3A-3F. (FIG. 3A) Images of blue (D=218 nm), cyan (D=285 nm), green (D=308 nm), yellow (D=346 nm), and red (D=394 nm) cPhCs showing uniform color in wafer scale. (FIGS. 3B-3C) Top-view SEM images of cyan cPhC (FIG. 3B) and (FIG. 3C) yellow cPhC. (FIG. 3D) Cross-sectional SEM image of red cPhC. (FIG. 3E) Reflectance spectrum of 5 cPhCs. (FIG. 3F) Absorbance spectrum of dye solutions before and after (′) mixing with VOCs. Pararosaniline (Dye 1) and 4,4′-azodianiline (Dye 2) were mixed with acetaldehyde, thymol blue (Dye 3) with acetone, and methyl red (Dye 4) with acetic acid.

FIGS. 4A-4B. Photos of the silica/ETPTA films after spin coating and UV curing, showing no vivid color before HF etching. (FIG. 4A) D=285 nm, (FIG. 4B) D=346 nm.

FIGS. 5A-5B. Cross-sectional SEM images of the cured spin-coated film of silica nanoparticles (D=308 nm) in ETPTA before HF etching. Silica nanoparticles are protruded to the air interface without plasma etching.

FIGS. 6A-6E. SEM images of cPhCs fabricated from silica nanoparticles with different diameters: (FIG. 6A) D=218 nm, (FIG. 6B) D=285 nm, (FIG. 6C) D=308 nm, (FIG. 6D) D=346 nm, and (FIG. 6E) D=394 nm. (i) top-view, (ii) cross-sectional view zoomed in on the top, and (iii) cross-sectional view of the whole film.

FIGS. 7A-7C. (FIG. 7A) Schematic illustration of possible flow directions during the spin coating process, with a schematic illustration of the slanted shear flow along the film thickness. (FIG. 7B) Schematic showing a cross-sectional view at the top and bottom of the film, highlighting different interparticle distances. (FIG. 7C) Cross-sectional SEM images zoomed at the top and bottom of the film, revealing different interparticle distances.

FIG. 8. Reflectance spectra of the Yellow cPhCs (D=354 nm) that were HF etched for 30 sec. and 1 h, respectively.

FIGS. 9A-9D. Chemical structures of dyes and their reactions upon exposure to VOCs: (FIG. 9A) pararosaniline with acetaldehyde, (FIG. 9B) 4,4′-azodianiline with acetaldehyde, (FIG. 9C) thymol blue with acetone, and (FIG. 9D) methyl red with acetic acid.

FIGS. 10A-10F. (FIG. 10A) Reflectance spectrum of the Yellow cPhC with the absorption peak positions of Dye 1 and Dye 1′ (after acetaldehyde mixing) shown as vertical lines. (FIG. 10B) Reflectance spectrum of Dye 1 casted on the Yellow cPhC before (Dye1-Yellow) and after (Dye1′-Yellow) exposure to acetaldehyde at 5 ppm. (FIG. 10C) Reflectance spectrum of the Cyan cPhC with the absorption peak positions of Dye 1 and Dye 1′. (FIG. 10D) Reflectance spectrum of Dye1-Cyan and Dye1′-Cyan (exposed to acetaldehyde at 5 ppm). (FIG. 10E) Reflectance spectrum of the cyan cPhC with the absorption peak positions of Dye 2 and Dye 2′. (FIG. 10F) Reflectance spectrum of Dye2-Cyan and Dye2′-Cyan (exposed to acetaldehyde at 5 ppm). Insert image shows the color change.

FIGS. 11A-11B. (FIG. 11A) Reflectance spectrum of Dye 1 casted on pure ETPTA film before (Dye1-ETPTA) and after (Dye1′-ETPTA) exposure to acetaldehyde at 5 ppm. (FIG. 11B) Reflectance spectrum of Dye2-ETPTA and Dye2′-ETPTA (exposed to acetaldehyde at 5 ppm). Insert image shows the color change.

FIGS. 12A-12E. (FIG. 12A) Schematic of the controlled VOC exposure setup. (FIG. 12B) Composition of the sensor array and use of a grey background (R=100, G=100, B=100). Results from the white paper are included in the last row for easy comparison of the effect of cPhCs. (c-e) Color difference maps at different concentrations of (FIG. 12C) acetaldehyde, (FIG. 12D) acetone, and (FIG. 12E) acetic acid. (LOD: limit of detection, PEL: permissible exposure limit.)

FIG. 13. Schematic showing the control dye spots. The same dye solution was cast on the same cPhC for n₁ times, and the array was exposed to N₂ n₂ times to take an image. Noise was calculated as the standard deviation of the total number of n₁+n₂ spots.

FIG. 14. Colorimetric sensor array response to acetaldehyde concentrations ranging from 1 to 1,000 ppm.

FIG. 15. Colorimetric sensor array response to acetone concentrations ranging from 0.1 to 1,000 ppm.

FIG. 16. Colorimetric sensor array response to acetic acid concentrations ranging from 0.02 to 1,000 ppm.

FIGS. 17A-17D. (FIG. 17A) Dye spots patterned on yellow cPhC. 1: Dye 1 without TsOH, 2: Dye 2 without TsOH, 3: Dye 3-2, 4: Dye 4-2. (FIG. 17B) Pattern exposed to acetone at 50 ppm displaying a number “6”. (FIG. 17C) Pattern exposed to acetic acid at 50 ppm displaying a number “3”. (FIG. 17D) Pattern exposed to acetaldehyde at 1,000 ppm displaying a number “8”.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated+10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value: they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

In contrast, chemically reactive dyes can change their molecular structures upon exposure to VOCs, leading to a color change for rapid detection of specific VOCs. Since each dye reacts differently with different types of VOCs, leading to different color changes, the chemo-responsive colorimetry sensing offers inherent selectivity. The ability to quantify color changes into three values (R, G, B) allows for higher data dimensionality. However, a significant limitation is often encountered at low VOC concentrations, where the color change may not be discernible by the naked eyes. Therefore, the raw data is typically amplified by converting RGB values from a range of 0-10 to 0-255 for better visualization.^{[}22,23]

In this study, we develop a highly sensitive colorimeter VOC sensor that integrates three-dimensional (3D) photonic crystals (PhCs) with chemoresponsive dyes. PhCs consist of periodic structures of two materials with different refractive indices, which create a photonic band gap (PBG) where light at specific wavelengths undergoes destructive interference in the crystal and is instead reflected back. This PBG, when in the visible wavelength range, gives rise to metallic-like structural colors. when fluorophores or quantum dots, which possess light-absorbing properties, are cast onto the PhC, their absorbance is enhanced depending on the overlap between their absorbance wavelength and the PBG of the PhC.^{[24-26]} To enhance the scalability and reproducibility of the fabrication process, we apply a dispersion of colloidal nanoparticles in triacry late monomer through spin-coating. Colloidal silica nanoparticles exhibit repulsion and spontaneously crystallize when they are beyond a critical volume fraction in triacrylate monomer (15%), without the need for evaporation. After partial etching of silica nanoparticles in the cured crystal, air cavities are generated to complete the colloidal PhCs (cPhCs). This method allows for the adjustment of reflectance peaks to be broad and intense. By casting various dyes onto these cPhCs of different periodicities and thus colors, we create a dye-cPhC array, resulting in a significant enhancement of dye color change upon VOC exposure.

### Experimental Section

### Materials

2-hydroxy-2-methylpropiophenone (Darocur 1173, 97%), basic fuchsin (pararosaniline), trimethylolpropane ethoxylate triacrylate (ETPTA, Mₙ˜428), and Triton X-100 are purchased from Sigma-Aldrich. 4,4′-Azodianiline (95%) and p-toluenesulfonic acid monohydrate (99%) are purchased from Acros Organics. Methyl red, hydroxylamine sulfate (HAS, 99%), 2-methoxyethanol, and acetaldehyde (99%) are purchased from Thermo Fisher Scientific. Sodium hydroxide (NaOH), ethanol (200 proof), acetone, methanol, and acetic acid are purchased from Fisher Chemical. Thymol blue is purchased from Spectrum Chemical. All the chemical reagents were used as received.

Fabrication and Characterization of cPhCs

Silica nanoparticles are synthesized by modified Stöber method via seeded growth. Narrowly dispersed silica seeds are first synthesized by slowly diffusing tetraorthosilicate (TEOS)/cyclohexane solution to the interface of the L-arginine aqueous solution at 60° C., followed by three-step the addition of the L-arginine aqueous solution into the seed solution following the recipe shown in Table 1. Specifically, TEOS is dripped into the mixture of 3 mL seed solution, 2.1 mL ammonium hydroxide, 8 mL water, and 24 mL ethanol at 0.8 mL/h using a syringe pump. The mixture is constantly stirred when TEOS is injected. After the synthesis, the particles are washed several times using ethanol (190 proof, Thermo Fisher Scientific Inc.). After the final centrifugation step, they are dried for 3 hours in a 60° C. convection oven, followed by dispersion of ˜1 g of silica in 10 mL of ethanol (200 proof, Thermo Fisher Scientific Inc.) using a sonicator for 6 hours. A 1% w/w of Darocur 1173 is dissolved in ETPTA, and this resin is added to the silica dispersion to achieve a 25% particle volume fraction. The dispersion is sonicated for an additional 10 min., and the solvent is evaporated overnight in a 60° C. convection oven. The solvent-free dispersion is then sonicated for 10 min. and spin-coated (WS-650, Laurell Technologies) onto a 4-inch Si wafer in two steps: 1) 200 rpm for 30 sec. and 1,000 rpm for 2 min. The acceleration rate for both steps is 100 rpm/s. The substrate is cured under UV light (270 nm, ˜ 1 mW/cm², UV-C LED strip light from Waveform Lighting) for 20 min. in a nitrogen atmosphere and then immersed in a 2% w/w hydrofluoric acid (HF) solution for 30 sec., followed by proper washing steps. The top-view and cross-section of the fabricated cPhC are characterized using high-resolution scanning electron microscope (HRSEM, Jeol 7500F). The reflectance of cPhCs is measured using a spectrometer (Ocean Optics USB4000), with the reflectance of a blank Si wafer set at 100% as the reference.

TABLE 1
Three-step seeded growth of silica nanoparticles.

| | L-arginine | H₂O | Seed | Cyclohexane | TEOS | Time |
|---|---|---|---|---|---|---|
| Step | (mg) | (mL) | (mL) | (mL) | (mL) | (h) |
| 1 | 9.1 | 6.9 | | 0.45 | 0.55 | 25 |
| 2 | 3 | 18 | 5 | 2.5 | 1.76 | 35 |
| 3 | 22.5 | 82.5 | 15 | 15 | 7.52 | 35 |

### Preparation and Characterization of the Dye-cPhC Sensor Array

p-Toluenesulfonic acid (TsOH) and NaOH aq. solution are prepared to be 2M and 1M, respectively. The molar ratios of pararosaniline to TsOH are adjusted to 1:4 (Dye 1-1) and 1:5.8 (Dye 1-2) in 2-methoxyethanol as the solvent. To aid the uniform casting and drying of the dye solution, the plasticizer Triton X-100 is added to the entire solution at concentrations of 2.5% (v/v, Dye 1-1) and 4.3% (v/v, Dye 1-2) (see summarized Table 2). 4,4′-azodianiline is dissolved in ethanol with a molar ratio to TsOH of 1:5.3 (Dye 2-1) and 1:7.3 (Dye 2-2). Triton X-100 is added at a concentration of 3.8% (v/v) in both cases. Thymol blue is prepared with HAS at a ratio of 1:15 (w/w) and dissolved in a solution of methanol, water, and 1M NaOH in a ratio of 6:4:1 (v/v). Triton X-100 is added at concentrations of 0.9% (v/v, Dye 3-1), and 4.3% (v/v, Dye 3-2) to act as a plasticizer but also to adjust the pH. Methyl red is dissolved in a solution of water and 1M NaOH in a ratio of 4:1 (v/v). Triton X-100 is not added to Dye 4-1, while Dye 4-2 has 1% (v/v). Each dye solution is freshly prepared and stirred for more than 10 min. before being cast onto cPhCs. A total of 8 dye solutions are cast onto 5 different cPhCs using a micropipette, resulting in a total of 40 unique dye-cPhC combinations in the sensor array. The sensor array is then dried in a vacuum oven at room temperature for one hour before being exposed to VOCs. UV-vis spectrophotometer (Varian Cary 5000) is used to characterize the absorbance peaks of the dyes before and after reacting to VOCs in the liquid state.

To compare the color enhancement effects of the cPhCs, reference materials such as white paper (Whatmann cellulose filter paper used for Dye 1 and Dye 2, and neutral Boise copy paper for pH sensitive Dye 3 and Dye 4) and a pure ETPTA film are employed. The pure ETPTA film is fabricated by infiltrating the prepolymer, where 1 wt % Darocur 1173 is dissolved in the ETPTA monomer (number-average molecular weight, Mₙ˜428), into the space between two glass slides with 50 μm thick polyimide tapes as the spacers, followed by UV curing.

TABLE 2
Dye solution formulations. TsOH: p-toluenesulfonic
acid, HAS: hydroxylamine sulfate.

| | Dye+ Acid/Salt | | |
|---|---|---|---|
| # | (molar ratio) | Solvent | Plasticizer |
| 1-1 | Pararosaniline + | 2-methoxyethanol | Triton X-100 |
| | 2M TsOH (1:4) | | (2.5% v/v) |
| 1-2 | Pararosaniline + | 2-methoxyethanol | Triton X-100 |
| | 2M TsOH (1:5.8) | | (4.3% v/v) |
| 2-1 | 4,4′-azodianiline + | ethanol | Triton X-100 |
| | 2M TsOH (1:5.3) | | (3.8% v/v) |
| 2-2 | 4,4′-azodianiline + | ethanol | Triton X-100 |
| | 2M TsOH (1:7.3) | | (3.8% v/v) |
| 3-1 | Thymol blue + | methanol + water + | Glycerol |
| | HAS (1:15 w/w) | 1M NaOH (6:4:1 v/v) | (0.9% v/v) |
| 3-2 | Thymol blue + | methanol + water + | Glycerol |
| | HAS (1:15 w/w) | 1M NaOH (6:4:1 v/v) | (4.3% v/v) |
| 4-1 | Methyl red | water + 1M NaOH | n/a |
| | | (4:1 v/v) | |
| 4-2 | Methyl red | water + 1M NaOH | Triton X-100 |
| | | (4:1 v/v) | (1% v/v) |

### Voc Exposure

Computer-controlled mass flow controllers (MFCs, MKS 1179) are utilized to regulate the flow rates of N₂ and the VOC sample. Due to the relatively high vapor pressure of VOCs at room temperature, an ice bath or dry ice bath is used to lower the temperature of the VOCs. The flow rate of the VOC sample line is fixed at 10 sccm, while the flow rates of the other N₂ lines for dilution are adjusted accordingly to achieve the desired VOC concentration. The sensor chamber, where the VOC and N₂ vapor mixture is exposed to the sensor array, is made of polypropylene because acetone, one of the VOCs being tested, requires a container resistant to it. All components are connected using Teflon tubing.

### Image Analysis

The images of the dye-cPhC sensor array are taken using a smartphone (Samsung Galaxy Z Flip5) in a controlled lightbox before and after exposure to VOCs. To ensure consistent lighting conditions and minimize noise during photography, a fixed light source (iPad Air 3, white screen) is positioned at a fixed distance with 0-degree incident angle relative to the sensor array. The position of the smartphone is also fixed. Images are analyzed using the Color Histogram plugin in ImageJ. Each dye spot is cropped to a circular shape to ensure consistency in measurement, and the mode value of the R, G, B values of all pixels within the circle is selected as the representative R, G, B for each dye-cPhC spot. The color differences before and after VOC exposure are calculated as follows: ΔR=R_{after}−R_{before}, ΔG=G_{after}−G_{before}, and ΔB=B_{after}−B_{before}. The results are visualized by adding these ΔR, ΔG, and ΔB values to a grey background (R=100, G=100, B=100) and plotting them as colors for each spot in the array.

Preparation and Characterization of cPhCs

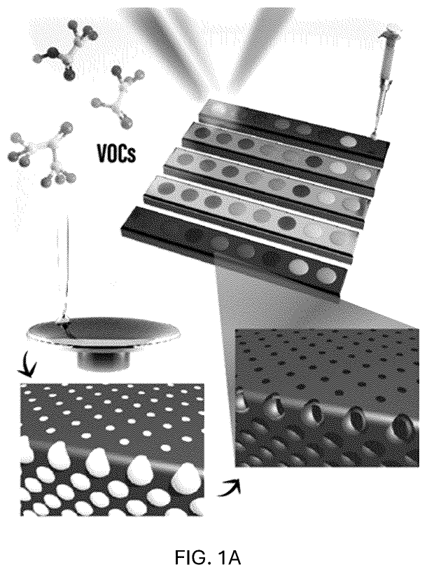

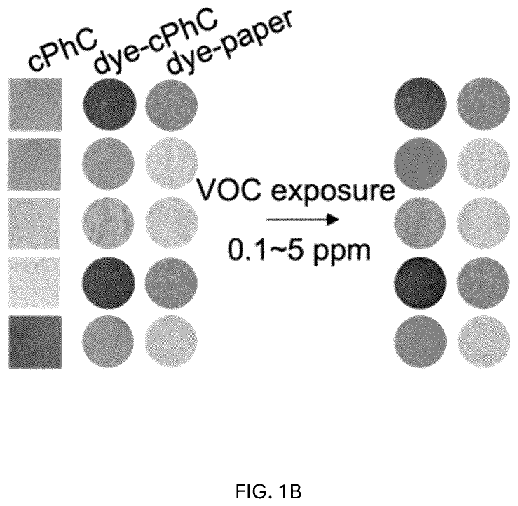

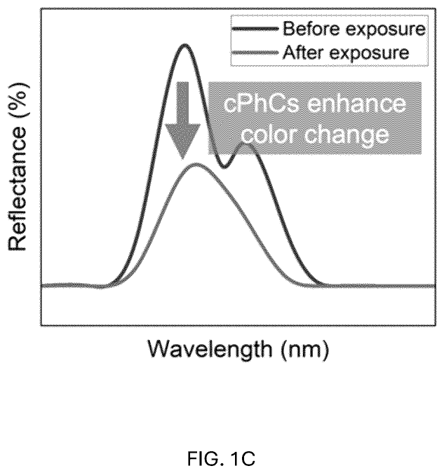

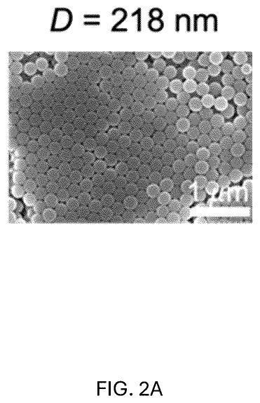

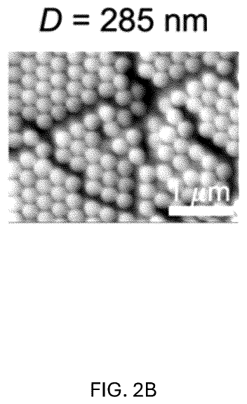

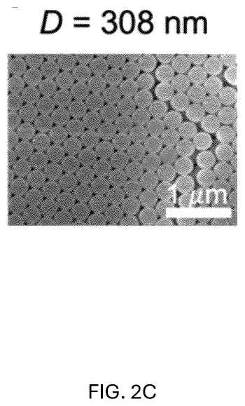

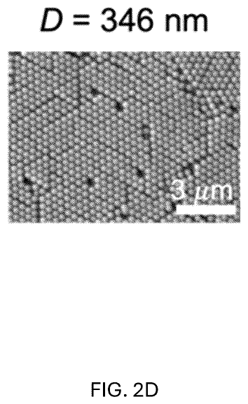

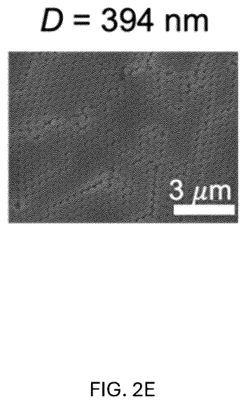

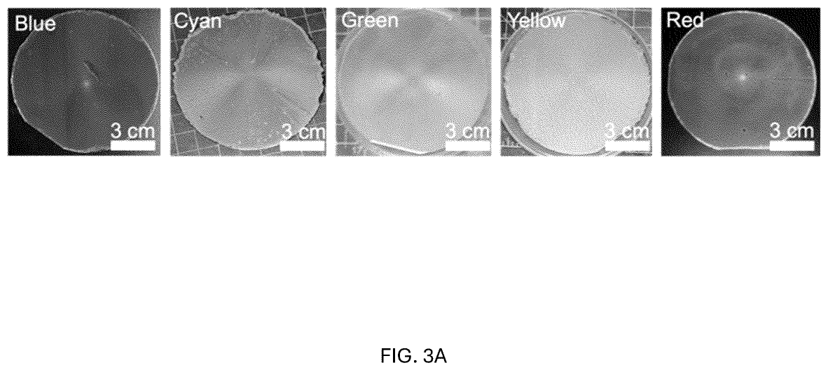

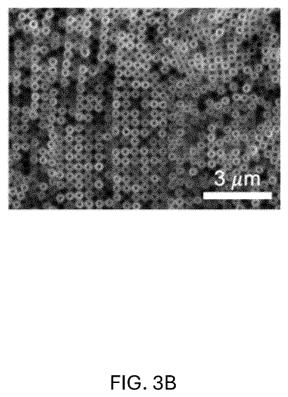

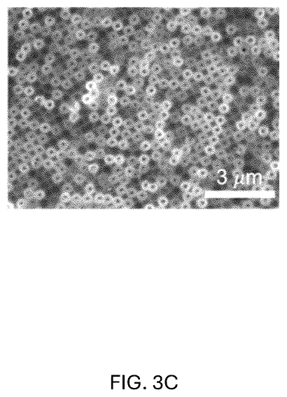

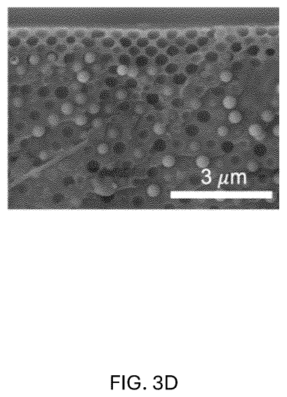

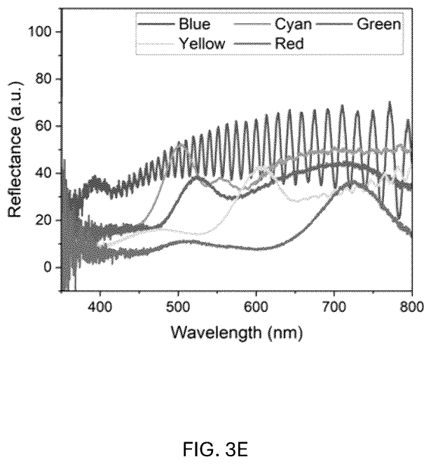

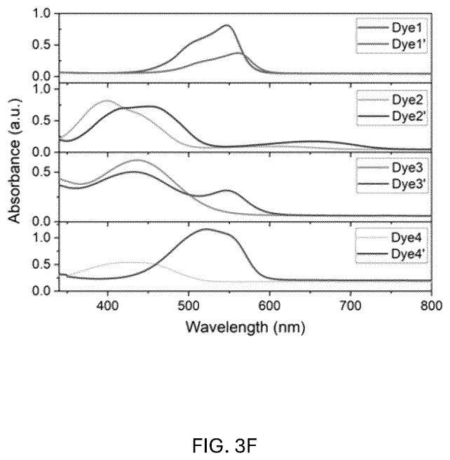

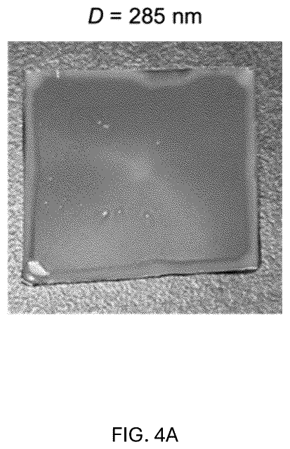

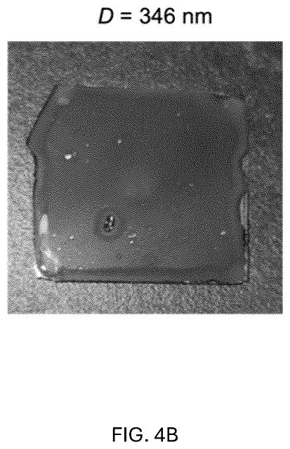

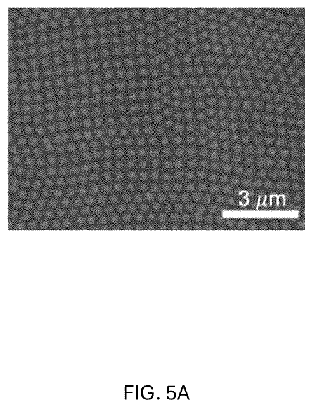

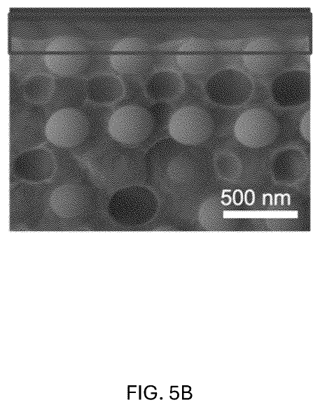

The schematic in FIG. 1A illustrates a process of casting dye solutions onto cPhCs to create a dye-cPhC array, which is then exposed to VOCs. The cPhCs consist of periodic holes in an ETPTA polymer matrix, where the color is determined by the size and periodicity of these holes. To create cPhC templates exhibiting five distinct structural colors, we synthesize five sets of monodisperse silica particles with diameters (D) of 218, 285, 308, 346, and 394 nm (FIGS. 2A-2E and 3B). The particles are then incorporated into the photo-crosslinkable monomer ETPTA, which has a refractive index (n=1.47 at 589 nm) matching that of silica (n=1.45 at 589 nm) to reduce van der Waals attraction. The silica nanoparticles behave like soft spheres, experiencing electrostatic repulsion from the electric double layer and steric hindrance from the solvation layer formed by hydrogen bonds between silanol and acrylate groups. Therefore, the silica nanoparticles self-assemble into a non-close-packed crystal structure. We adjust the particle concentration to 25 vol %, exceeding the critical threshold for soft sphere crystallization yet keeping it low enough to prevent close-packing so that we can achieve broader reflective peaks. The dispersion is applied onto silicon wafers via spin-coating, followed by curing them under UV light in a nitrogen atmosphere. The silica is removed by immersing the wafers in a 2% hydrofluoric acid (HF) aqueous solution for 30 s, resulting in vivid structural colors (see FIGS. 3A and 4A-4B).

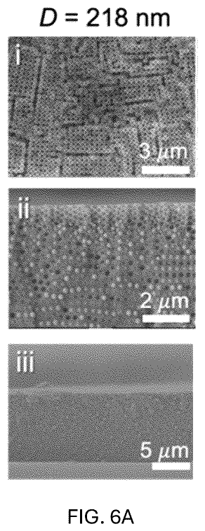

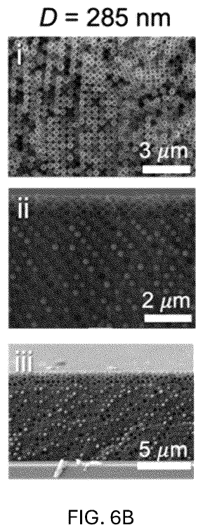

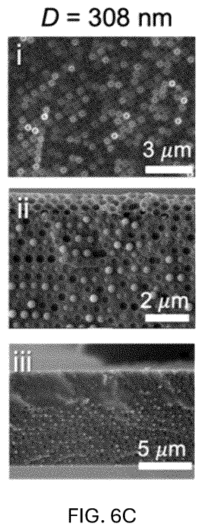

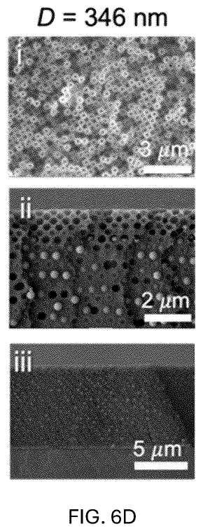

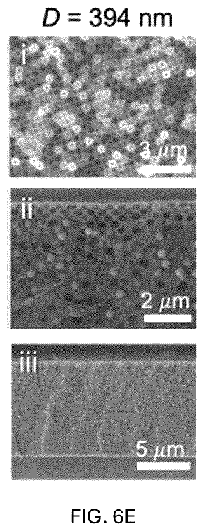

The top-view SEM images (FIGS. 3B-3C) shows the surface pores which means that the silica nanoparticles were protruded to the ETPTA surface before HF etching, which was confirmed in FIGS. 6A-6E. Both top-view and cross-sectional SEM images reveal the formation of face centered cubic (FCC) {200} planes on the surface instead of FCC {111} (FIGS. 3B-3D and FIGS. 6A-6E). In addition, the measured reflectance peaks (λ_{refl}) of the cPhCs (see FIG. 3E) significantly deviate from the expected ones from FCC {111} planes previously reported, rather they can be calculated from {200} planes. The particle volume fraction (ϕ) is derived by directly measuring the interplanar distance (d) from the cross-sectional SEM images for each substrate (see FIGS. 6A-6E). In the case of FCC {200} planes, d is half the lattice constant (a) for Bragg's diffraction,

$$ϕ = \frac{2 {D}^{3} π}{3 {a}^{3}} = \frac{{D}^{3} π}{12 {d}^{3}} \qquad ( 1 )$$

For Bragg's diffraction,

$${λ}_{refl} = 2 {n}_{eff} d \qquad ( 2 )$$

$${n}_{eff} = \sqrt{{n}_{1}^{2} ϕ + {n}_{2}^{2} ( 1 - ϕ )} \qquad ( 3 )$$

where n_{eff} is the effective refractive index, n₁ and n₂ are refractive index of air and ETPTA, respectively. The calculated λ_{refl} based on FCC {200} and the observed d are well aligned with the experimental data summarized in Table 3.

TABLE 3
Diameter of silica particles (D), interplanar distance (d), particle
volue fraction (ϕ), effective refractive index (n_{eff}), and calculated
wavelength of reflection peaks (λ_{refl}) of cPhCs.

| Color | D (nm) | d (nm) | Φ | n_{eff} | λ_{refl} (nm) |
|---|---|---|---|---|---|
| Blue | 218 | 162 | 0.621 | 1.201 | 389 |
| Cyan | 285 | 213 | 0.627 | 1.197 | 510 |
| Green | 308 | 227 | 0.653 | 1.184 | 537 |
| Yellow | 346 | 258 | 0.631 | 1.195 | 616 |
| Red | 394 | 296 | 0.617 | 1.202 | 712 |

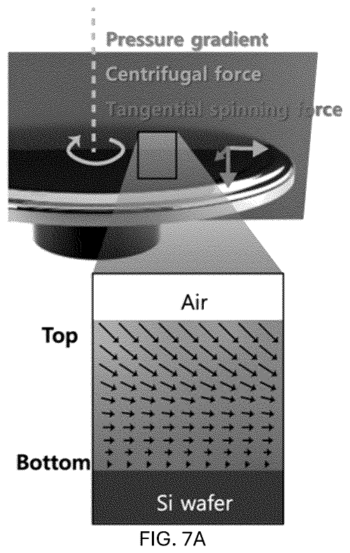

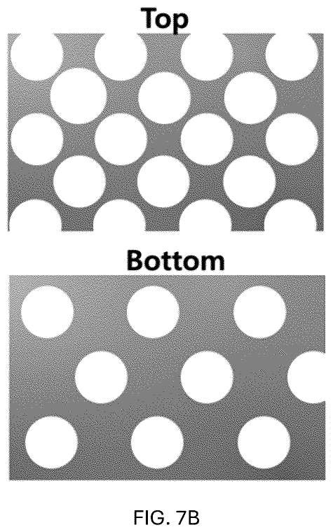

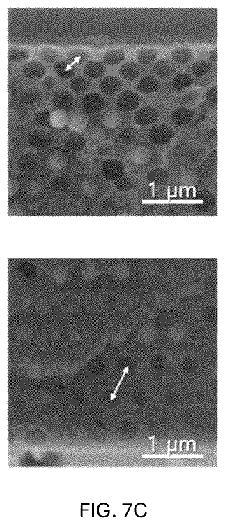

For the deviation from the typical {111} planes in a FCC crystal to {200} planes in our system, one possible explanation could be the dynamic shear force in spin-coating, along the film thickness. When the dispersion spin-off at the wafer edge by centrifugal force, the neighboring nanoparticles move to the vacancies to keep the continuity of the film, resulting in a pressure gradient exerted normal to the film. This can create three distinct flow regimes: downward from the pressure gradient, outward from centrifugal force, and tangential from spinning force (see FIG. 7A). Combining these flows, slanted shear flow will be formed which can facilitate the formation of FCC {200} planes (FIGS. 7A-7C). Similar speculations have been proposed in literatures when spin coating and direct ink printing of the silica/ETPTA systems, leading to the observation of the {200} planes.

Our experimental results indirectly confirm the occurrence of a complex shear flow, as evidenced by cross-sectional SEM images revealing that the interparticle distance (d_{id}) at the top is smaller than at the bottom (FIGS. 6Aiii-6Eiii and FIG. 7C). This observation suggests that the downward movement of colloidal particles, primarily happening at the top, reduces the d_{id} there, while the particle-depleted portion is expelled outward. The bottom part, less affected by the normal pressure gradient, appears to have a wider d_{id}. In fact, the observed d_{id} at bottom of the film, 548 nm±31.5 nm (FIGS. 6A-6E) match the calculated d_{id}, 558 nm, for the 25% v/v condition considering that the crystal lattice is an FCC,

$${d}_{id} = \frac{1}{\sqrt{2}} a = \sqrt[3]{\frac{π ϕ}{3 \sqrt{2}}} D \qquad ( 4 )$$

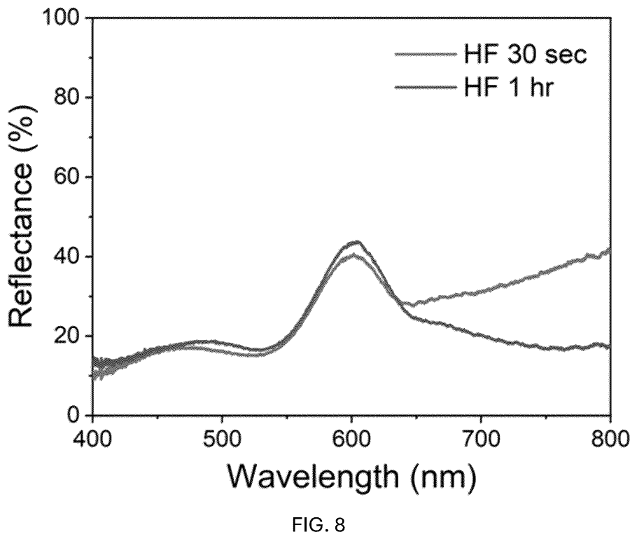

Additionally, the bottom portion of the colloidal assembly is polycrystalline, likely attributed to the minimal shear interaction between the nanoparticle dispersion and the wafer. Within a whole film thickness of 7 to 9 μm (see FIGS. 6Aiii-6Eiii), silica nanoparticles are etched by HF to a depth of 1 μm, equivalent to 4-6 layers from the top, following limited exposure to an HF solution. The primary reflective peak originates from these top layers. The silica/ETPTA region demonstrates no or minimal peaks for several reasons: firstly, the contrast in refractive index is as low as 0.02: secondly, the colloidal arrangement lacks sufficient crystallinity to establish a photonic bandgap; and lastly, any potential reflective peaks do not appear within the visible spectrum due to the large interplanar distance and a higher effective refractive index than the top layer portion. In fact, even after all silica nanoparticles are completely etched away from the cured film after 1 hour, there is no significant change in the intensity of the reflectance peak, suggesting 30 sec is enough to achieve high reflectance (FIG. 8).

This simple cPhC fabrication method allows for the creation of uniform colors, even at a large scale (4-inch wafer). Furthermore, the unique {200} plane formation can use larger silica nanoparticles than those used in other colloidal PhC studies, making it more scalable due to the better yield of larger particles in silica synthesis. Lastly, the peaks generated in the upper 3-4 layers alone provide a sufficiently intense reflection, and the broadness of the peaks originating from the polycrystalline lower part is advantageous in our system when combined with the dyes, which will be discussed in the later section.

### Preparation and Characterization of Dye Solutions

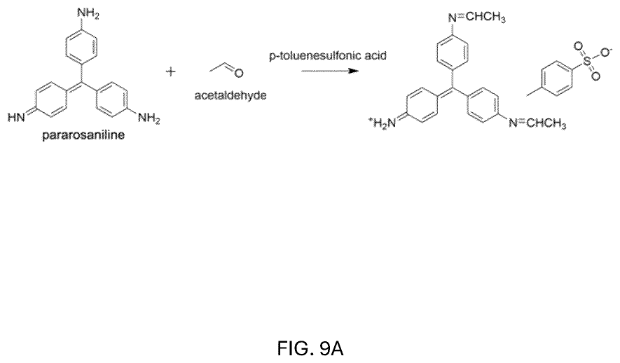

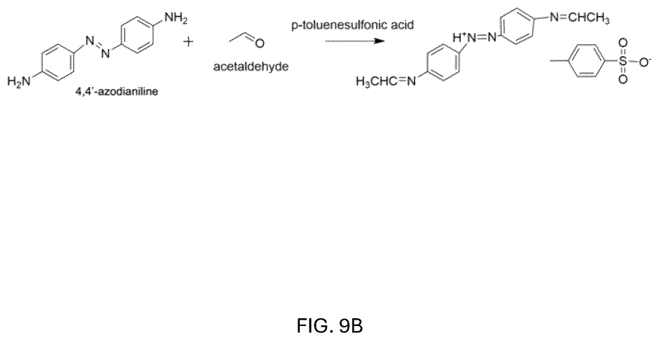

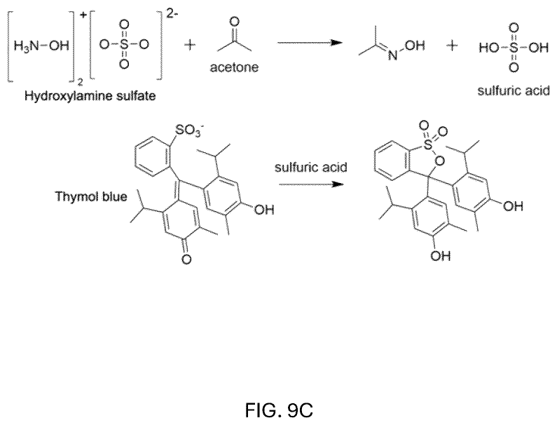

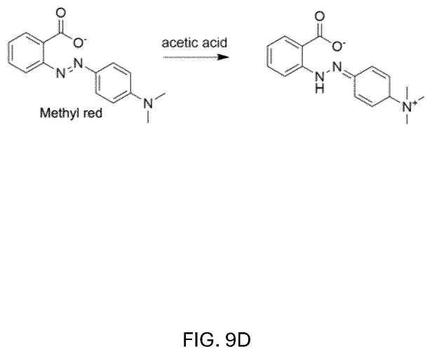

To demonstrate the effectiveness of our dye-cPhC system, we choose acetaldehyde, acetone, and acetic acid among the common VOCs as our targets for testing against. For effective sensing of these compounds, we select two amine-containing solvatochromic dyes, parosaniline and 4,4′-azodianiline, for our dye candidates to form a colorimetric array. Both of these dyes react with acetaldehyde and acetone in the presence of sulfur oxoacids (e.g. p-toluenesulfonic acid, TsOH) to form imines, thereby absorbing light at different wavelengths (see FIGS. 9A-9D and 3G). Dye 1 and Dye 2 in FIG. 3F correspond to pararosaniline and 4,4′-azodianiline, respectively, and the absorbance in solutions before and after mixing with acetaldehyde is shown. The sensitivity of these dyes is highly dependent on the molar ratio of dye to TsOH. Therefore, we decide to use two different molar ratios for each dye (1:4 and 1:5.8 for Dye 1 and 1:5.3 and 1:7.3 for Dye 2) to vary their reactivity, one to response at a lower concentration of VOCs while the other at a higher concentration. (see Table 2 for detailed dye recipe).

For candidate of Dye 3, we select thymol blue to target acetone.^{[39]} Hydroxylamine sulfate (HAS) is added to the dye solution, which generates sulfuric acid when reacted with acetone. The sulfuric acid then changes the pH of the dye solution, resulting in a molecular structure change of thymol blue (FIGS. 9C and 3G). The pH of the dye solution is adjusted to 5.4 using 1M NaOH to prevent a response to acetic acid such that to enhance selectivity. For Dye 4, we choose methyl red to target acetic acid. Like thymol blue, we adjust the pH of the methyl red solution to 9.2 using 1M NaOH so that when it encounters acetic acid (pKa of 4.76), its molecular structure changes, leading to a color change (FIGS. 9D and 3G). In all cases, the concentration of the dye dissolved in the solvent is crucial when casting it on top of cPhC. If the concentration is too low, the color of the cPhC dominates, making it less sensitive to VOCs. If the concentration is too high, the effect of the underlying cPhC is not observed. Therefore, taking all these factors into account, we create two optimized recipes for each of the four dyes, resulting in a total of eight dye solutions. These solutions are then cast onto five different cPhCs (blue, cyan, green, yellow, and red), producing a colorimetric array with 40 spots (FIG. 1A).

### Color Change Enhancement of Dye-cPhC Coupling

Dyes exhibit color by absorbing light at the characteristic wavelength (λ_{abs}), while the cPhCs show color by reflecting light at the characteristic wavelength, λ_{refl}. When each dye solution is cast onto five different cPhCs, the two colors overlap, causing the color of the spot to vary depending on which substrate the dye is cast on. This initial variation in color is observed before exposure to any VOCs. In several dye-cPhC couples, when the λ_{abs} overlaps with the PBG edge of the cPhC, the dye's absorption is maximized. Therefore, when the original λ_{abs} of the dye is outside the PBG and exposure to VOCs causes the peak to shift towards the PBG edge, the absorption is enhanced. This leads to an enhanced color change compared to that on the reference (e.g., white paper). This enhancement can also occur if the initial λ_{abs} overlaps with the PBG edge but shifts after exposure to VOCs, no longer overlapping with the PBG edge.

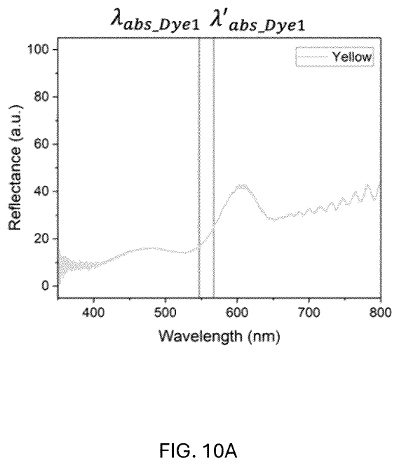

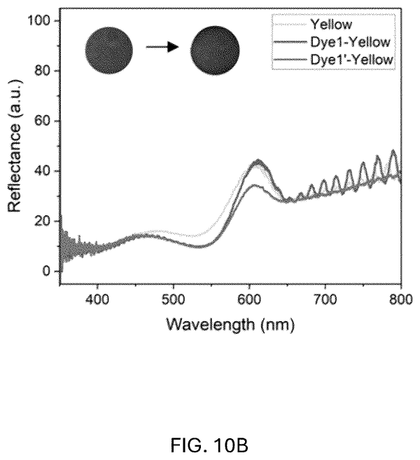

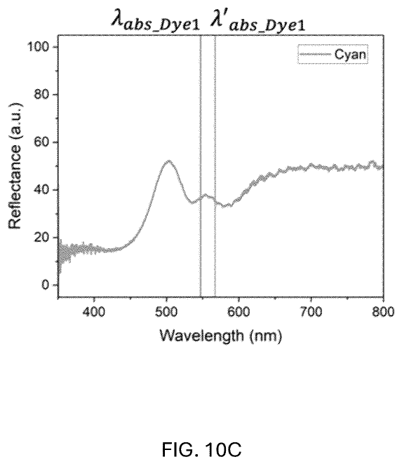

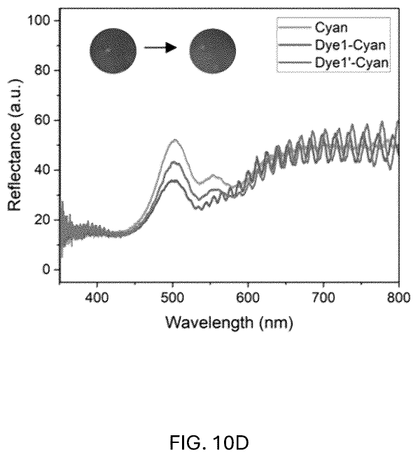

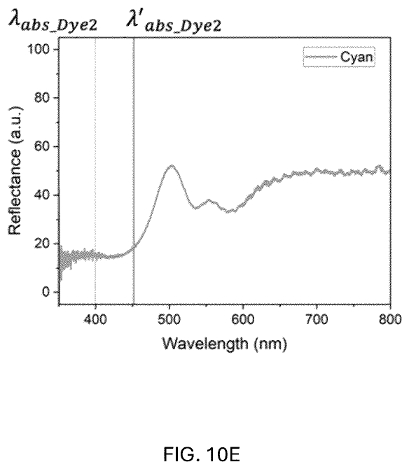

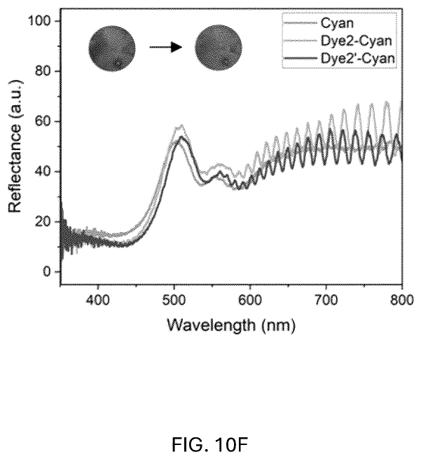

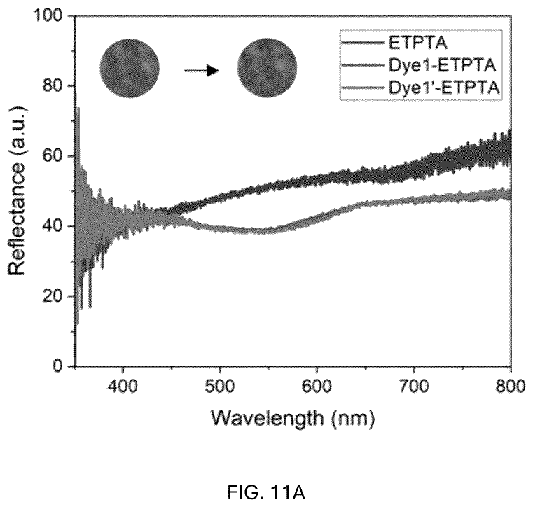

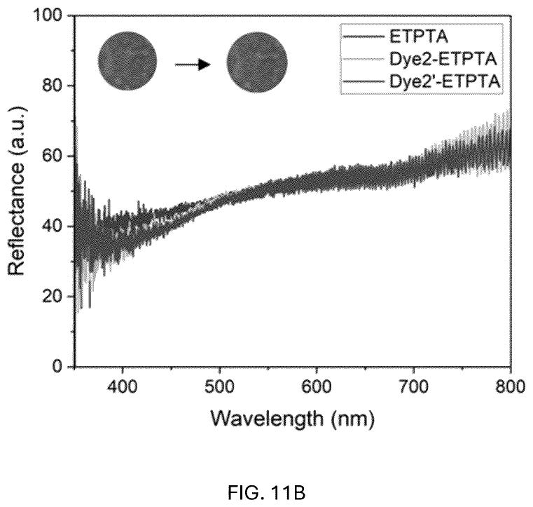

In order to confirm the color enhancement of dye-cPhC coupling, we conduct spectral analysis as shown in FIGS. 10A-10F. In FIG. 10A, λ_{abs} of pararosaniline before (λ_{abs_Dye1}) and after (λ′_{abs_Dye1}) exposure to acetaldehyde is plotted as a line graph on top of the yellow cPhC reflectance spectrum. λ_{abs_Dye1} is initially outside the PBG. After exposure, λ′_{abs_Dye1} reaches the PBG edge. When comparing the reflectance spectra of the spot where pararosaniline is cast onto the yellow cPhC (Dye1-Yellow) and the same spot exposed to 5 ppm acetaldehyde (Dye1′—Yellow) (FIG. 10B), we observe a decrease in reflectance around λ_{abs_Dye1}, indicating absorption in that region. However, for Dye1′-Yellow, we observe a more pronounced change in the shape and intensity of the reflectance peak, resulting in a visible color change. This effect is more noticeable when compared with the reference that is a pure ETPTA film without the hole structures. We cast the same dye solution on the reference and compared the reflectance before and after exposure to 5 ppm acetaldehyde (FIG. 11A). The absorption around the λ_{abs_Dye1} is clearly visible compared to the reflectance of pure ETPTA. However, there is little change in the spectrum after exposure to acetaldehyde, and no visible color change is observed. These results indicate that the cPhC significantly influences the light absorption of the dye.

When the same Dye 1 is cast onto a different cPhC, such as cyan (FIG. 10D, 10D), we observe that λ_{abs_Dye1} and λ′_{abs_Dye1} overlap with the PBG edge of Cyan's secondary peak. Despite no overlap with the main peak, a significant difference in reflectance between Dye1-Cyan and Dye1′-Cyan is observed, resulting in a noticeable color change (FIGS. 10C, 10D). When the overlap of λ_{abs} and PBG edge is not as pronounced, e.g., 4,4′-azodianiline (Dye 2) is cast onto cyan cPhC, the difference in reflectance before and after exposure, as well as the color change, is less pronounced compared to the previous cases (see FIGS. 10E, 10f). However, when compared with the reference sample (FIG. 11B), there is still some noticeable difference. This suggests that our dye, due to its broad λ_{abs}, can still achieve color enhancement even if the main peak does not perfectly lie on top of the PBG edge, as long as some part of the peak extends into the PBG.

In this way, the advantage of our colorimetric array lies in the relatively broad absorption peak of the dye and the cPhC's reflectance peak, which increases the likelihood to overlap with each other. As a result, we achieve an overall color enhancement effect, compared to the method of casting dye on a white paper, although the degree of enhancement may vary among spots.

### Colorimetric Sensor Array Response to VOCs Exposure

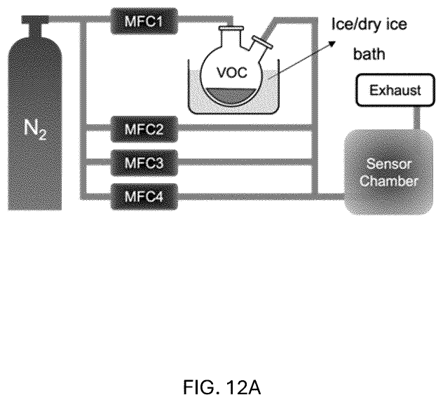

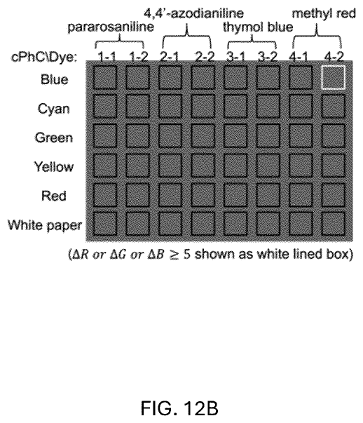

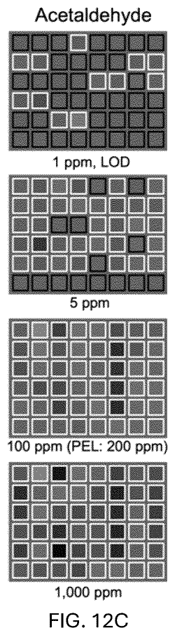

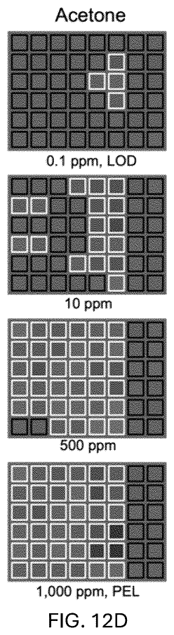

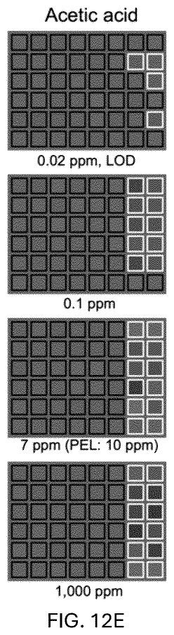

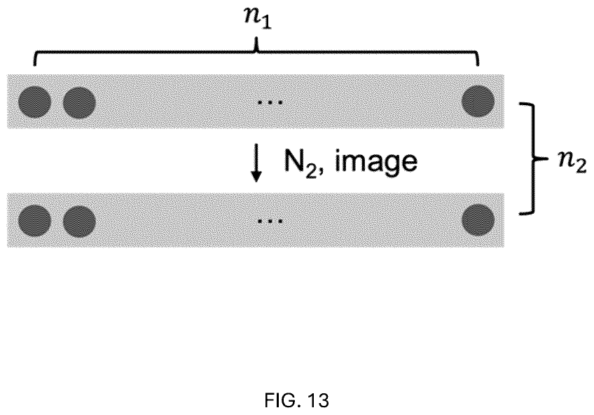

We expose the array of 40 spots of the dye-cPhC, from the combination of different dye solutions and 5 different cPhCs, to VOC from 0.02 ppm to 1,000 ppm using a MFC setup (FIG. 12A). To lower the VOC concentration to be less than 1,000 ppm, we lower their vapor pressure by using an ice bath or dry ice bath. We extract the R, G, B values from each spot of the dye-cPhC array and calculate the difference before (R, G, B) before and after (R, G, B)_{after} exposure to VOCs as follows: ΔR=R_{after}−R_{before}, ΔG=G_{after}−G_{before}, ΔB=B_{after}−B_{before}. We then visualize the results by adding these differences to a grey background (R=100, G=100, B=100) and plotting them as colors for each spot in a square (FIG. 12B). The limit of detection (LOD) of the colorimetric array is determined by the minimum VOC concentration that would produce a response equal to 3σ, where σ is the noise from RGB extraction without VOC exposure. To quantify the noise, the same dye solution is cast onto the same cPhC n₁ times and then exposed to N₂ for n₂ times to obtain images before and after exposure (FIG. 13). The n₁ samplings capture the noise related to the drying process of the dye on the cPhC, while the n₂ samplings include noise that could arise during the photographing process. The σ of the combined n₁+n₂ control spots is calculated to be 1.4. Therefore, we consider ΔR or ΔG or ΔB≥3σ≈5 as a meaningful color change, which we highlight with a white-lined box in the color difference map as shown in FIG. 12B. Additionally, to better compare the color enhancement on cPhCs, we also cast the same dye solution on the white paper to observe the color change, which is included in the last row (6^{th}) of the color difference map.

The color change due to acetaldehyde exposure is observed to begin at 1 ppm, LOD. It is worth noting that we did not amplify ΔR, ΔG, and ΔB to better visualize the color change. The color change appears within 1 min. of exposure to VOC, indicating a very rapid reaction. Since all dyes used are reactive to acetaldehyde, responses are observed across all spots. Among them, the color change starts first on the best substrate for each dye. For example, for Dye 1 cast in the 1^{st} and 2^{nd} columns, as mentioned in FIGS. 10A-10F, the λ_{abs-Dye1} Or λ′_{abs-Dye1} is aligned with the PBG edge of the yellow and cyan cPhCs, respectively. Therefore, significant color changes are observed on these two cPhCs first. Furthermore, for Dye 1-2, the molar ratio of dye:TsOH is 1:5.8, which is higher than 1:4 for Dye 1-1. This higher TsOH ratio results in higher |ΔR|, |ΔG|, and |ΔB | in the 2^{nd} column compared to the 1^{st} column, indicating that higher TsOH concentrations lead to more color changes. For Dye 2 cast in columns 3 and 4, λ′abs-Dye2 overlaps most with the Red cPhC's edge (FIGS. 3E, 3F), confirming that the color change starts first on red cPhC. Similar to Dye 1, the molar ratio of the dye:TsOH for Dye 2-2 (1:7.3) is higher than that for Dye 2-1 (1:5.3), therefore, Dye 2-2 shows earlier reaction on the blue cPhC.

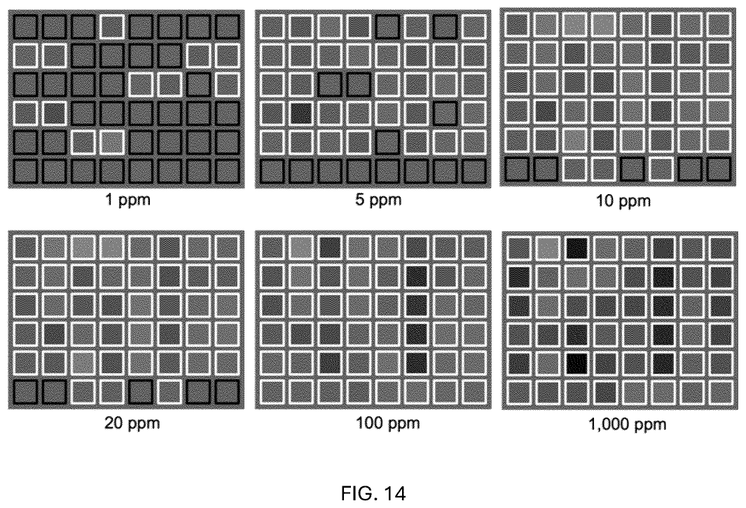

As the acetaldehyde concentration increases to 5 ppm, more spots exhibit distinguishable color changes. Importantly, there are no changes observed yet on paper at this concentration. As shown in FIG. 14, the color changes become more pronounced with higher concentrations. At 100 ppm, which is 100 times the LOD, the color changes on paper substrates finally become significant, while the dye spots on cPhCs already exhibits much larger color changes. Permissible exposure limit (PEL) is a regulatory limit of hazardous substances in air set by Occupational Safety and Health Administration (OSHA). Acetaldehyde's PEL is 200 ppm, but our colorimetric array shows a clear color change even at 1 ppm. This indicates that our array can rapidly detect the presence of VOCs at levels considered hazardous.

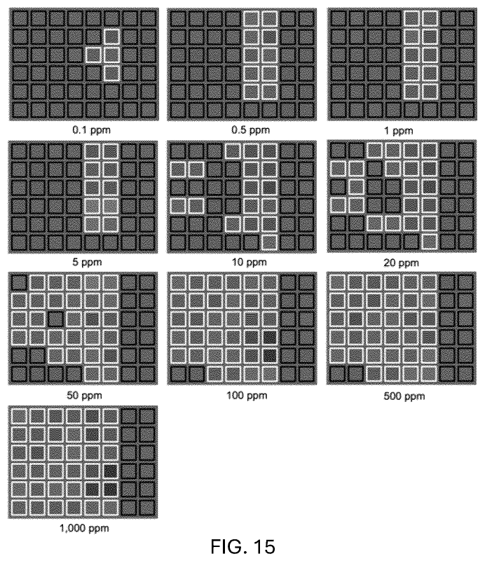

When the same array is exposed to another target VOC, acetone, the LOD is observed to be 0.1 ppm, with Dye 3 showing the earliest response (FIG. 12D). Among them, both Dye 3-1 and Dye 3-2 begin to react on the green cPhC, as the λ′_{abs-Dye3} overlaps with the green cPhC's PBG edge (FIGS. 3E, 3F). In addition to green, Dye 3-2 also reacts on cyan and yellow, suggesting Dye 3-2 being more reactive than Dye 3-1, and the partial overlap of λ_{abs-Dye3} and λ′_{abs-Dye3} with the PBG edges of cyan and yellow cPhCs. Since Dye 3 also reacts to acetaldehyde, looking at the results at 1 ppm of acetaldehyde (FIG. 12C), we can see that it also first reacts on the best substrate, yellow. Acetone has a PEL of 1,000 ppm. With our sensor array, results at 500 ppm (FIG. 12D) already show a clear color difference. Another point to note is that Dye 1 and Dye 2 also react to acetone, although not as strongly as to acetaldehyde. Results for all concentrations from 0.1 to 1,000 ppm are presented in (FIG. 15), where Dye 3 shows a clear color change from the lowest to highest concentration, Dye 1 and Dye 2 start changing color from 10 ppm, and Dye 4 shows no reaction throughout. As seen, the disclosed technology generates a unique color difference map specific to acetone, distinct from acetaldehyde.

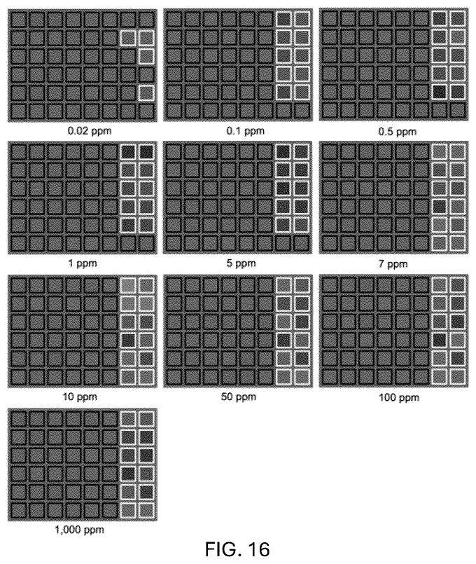

Lastly, we examine the results of exposing the array to acetic acid (FIG. 12E and FIG. 16). The LOD for acetic acid is found to be 0.02 ppm, with Dye 4 exhibiting a response. Notably, both Dye 4-1 and Dye 4-2 show enhancement on cyan, where the λ′_{abs-Dye4} overlaps with the PBG edge. Additionally, reaction from Dye 4-2 is enhanced on green and red, likely due to its higher reactivity compared to Dye 4-1, and the partial overlap of the broad λ′abs-Dye4 with the edges of green and red. Dye 4 also reacts to acetaldehyde (pKa of 13.57), as evident at 1 ppm (FIG. 12C), where it first shows on the best substrate, cyan. However, it does not exhibit a response to acetone (pKa of 19.3). Acetic acid has a PEL of 10 ppm, and a clear color change is already visible at 7 ppm (FIG. 12E). Total results ranging from 0.02 to 1,000 ppm are presented in FIG. 16, showing that Dye 1 to Dye 3 do not exhibit any reaction. This is because Dye 1 and Dye 2 are reactive only to aldehydes and ketones, while Dye 3, a pH indicator, changes color only in the presence of strong acid, such as sulfuric acid formed from the reaction of acetone with HAS. Therefore, weak acids such as acetic acid, especially in a small amount, do not induce a color change in Dye 3. Thus, our dye-cPhC array demonstrates a unique color map for acetic acid, distinct from those acetaldehyde and acetone. This underscores the disclosed technology's utility for use in arrays and in multiplexing.

### Patterning Color Dot Arrays for Recognition

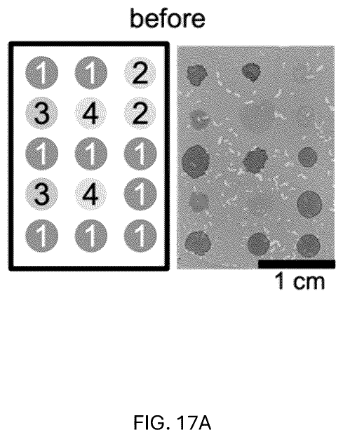

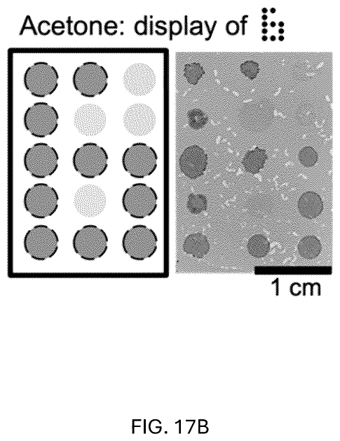

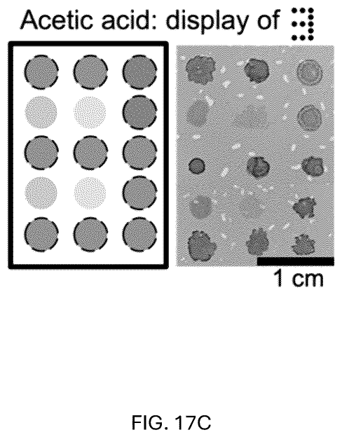

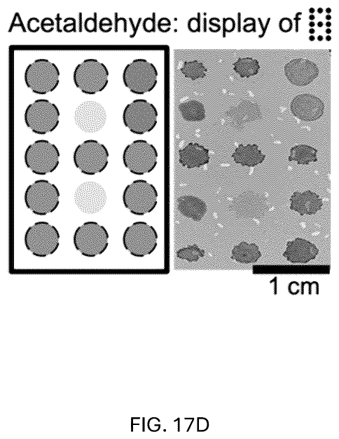

Based on the data presented in FIGS. 14-16, the dye-cPhC dot array produces distinct color maps in response to different VOC exposures. To aid the visual recognition of the different VOCs, we patterned the color dots in digit numbers (FIGS. 17A-17D). Dye spots labeled 1 and 2 were prepared using Dye 1 and Dye 2 without TsOH, while dye spots labeled 3 and 4 utilized Dye 3-2 and Dye 4-2, respectively (FIG. 17A). Initially, the pattern displays no recognizable numbers. However, exposure to 50 ppm of acetone results in displaying the number “6” (FIG. 17B). Similarly, exposure to 50 ppm of acetic acid displays the number “3” (FIG. 17C), and exposure to 1,000 ppm of acetaldehyde reveals the number “8” (FIG. 17D). The programmed patterns allow for the effective differentiation of various VOCs, providing a visually intuitive representation of the results.

### CONCLUSIONS

In this study, we developed a colorimetric sensor array using chemically-reactive dyes integrated with cPhCs for the detection of VOCs. The integration of cPhCs enhanced the color change of the dyes by leveraging the overlap between the cPhCs' PBG and the dyes' absorption peak. This overlap increased dye absorbance, altering the overall light reflectance of the dye-cPhC system and resulting in a more pronounced color change upon VOC exposure. Our method of creating cPhCs, spin-coating a nonvolatile dispersion of silica particles in ETPTA, offered a simple and scalable approach. The dye-cPhC sensor array produced unique color difference maps for acetaldehyde, acetone, and acetic acid, respectively, demonstrating the array's ability to differentiate between these VOCs. The LOD for acetaldehyde was 1 ppm, for acetone 0.1 ppm, and for acetic acid 0.02 ppm, highlighting the array's sensitivity. Importantly, these LODs were achieved without the need for amplification of the RGB difference before and after exposure to VOCs. Furthermore, by utilizing patterning, we demonstrated that the VOC exposed color array can be used for recognition and differentiation.

### ASPECTS

The following Aspects are illustrative only and do not limit the scope of the present disclosure or the appended claims. Any part or parts of any one or more Aspects can be combined with any part or parts of any one or more other Aspects.

Aspect 1. A colorimetric component, comprising: a first photonic crystal, the first photonic crystal having a reflectance spectrum having a stopband in the range of visible light; and a first dye, the first dye being sensitive to a volatile compound, the volatile compound comprising at least one of a volatile organic compound (VOC) and a volatile sulfur compound (VSC), the first dye characterized as undergoing a change in molecular structure when contacted to the volatile compound, and the first photonic crystal and the first dye being selected such that the colorimetric component exhibits a change in visible color when contacted with the volatile compound.

Aspect 2. The colorimetric component of claim 1, wherein (i) the first photonic crystal exhibits a reflectance spectrum having a stopband edge, (ii) the first dye absorbs light at a characteristic wavelength peak outside the stopband edge when free of contact with the volatile compound, (iii) when the first dye is contacted with the volatile compound, the characteristic wavelength peak shifts closer to or within the stopband edge.

Aspect 3. The colorimetric component of claim 1, wherein (i) the first photonic crystal exhibits a reflectance spectrum having a stopband edge, (ii) the first dye absorbs light at a characteristic wavelength peak within the stopband edge when free of contact with the volatile compound, and (iii) when the first dye is contacted with the volatile compound, the characteristic wavelength peak shifts outside of the stopband edge.

Aspect 4. The colorimetric component of any one of Aspects 1-3, wherein the colorimetric component comprises a first section that comprises the first photonic crystal and the first dye, and wherein the colorimetric component comprises a second section that comprises at least one of (i) a second photonic crystal and (ii) a second dye.

Aspect 5. The colorimetric component of claim 4, wherein the second section comprises a second photonic crystal, the second photonic crystal differing from the first photonic crystal.

Aspect 6. The colorimetric component of any one of claims 4-5, wherein the second section comprises a second dye, the second dye differing from the first dye.

Aspect 7. The colorimetric component of any one of claims 1-6, wherein the first photonic crystal comprises a matrix having a periodic arrangement of holes, the holes optionally being substantially monodisperse.

Aspect 8. The colorimetric component of Aspect 7, wherein the matrix comprises a polymer.

Aspect 9. The colorimetric component of any one of Aspects 7-8, wherein the matrix comprises a plurality of particles in a periodic arrangement, the particles optionally being substantially monodisperse. Particle uniformity can be assessed by the polydispersity index (PDI), which can be determined through dynamic light scattering (DLS). The PDI value for particles according to the present disclosure can be, for example, less than 0.05. In some embodiments, the matrix is a polymer—for example, a triacrylate polymer—that is sufficiently rigid to preserve the original pore volume even after the particles are etched away. Consequently, the uniformity of the particles is mirrored in the monodispersity of the resulting pores size, which can be estimated by scanning electron microscopy.

Aspect 10. The colorimetric component of any one of Aspects 7-9, wherein the holes have an average diameter in the range of from about 180 to about 450 nm.

Aspect 11. The colorimetric component of any one of Aspects 1-10, further comprising at least one of an Brönsted acid, a Lewis acid or base, and a salt. Non-limiting examples include p-Toluenesulfonic acid (TsOH), glacial acetic acid, t-butylammonium hydroxide (TBAH), and sodium hydroxide (NaOH). Example salts include, without limitation, hydroxylamine sulfate (HAS), and silver nitrate (AgNO₃).

Aspect 12. The colorimetric component of any one of Aspects 1-11, wherein the dye comprises any one or more chemoresponsive dyes. Example dyes include, without limitation, (i) aldehyde/ketone-responsive 2,4-dinitrophenylhydrazine, 4,4′-azodianiline, and pararosaniline, (ii) pH indicators (e.g. Litmus, Cresol Red) for carboxylic acids, and (iii) solvatochromatic dyes for acetone and alcohols (e.g., Reichardt's dye, Merocyanine, and Nile Red).

Aspect 13. A method, comprising contacting a colorimetric component according to any one of Aspects 1-12 to a volatile compound.

Aspect 14. The method of Aspect 13, further comprising correlating a change in visible color in the colorimetric component to the volatile compound.

Aspect 15. A colorimetric component, comprising: n sections, an nth section of the n sections comprising a combination of a photonic crystal and a dye, the nth section exhibiting a change in color when contacted with a volatile compound, the volatile compound comprising at least one of a volatile organic compound (VOC) and a volatile sulfur compound (VSC), the n sections being arranged such that the colorimetric component exhibits a characteristic pattern when contacted with the volatile compound, the characteristic pattern correlated to at least one of (i) the volatile compound and (ii) a concentration of the volatile compound. Examples of such components are provided in, for example, FIGS. 1.12-1.17.

Aspect 16. The colorimetric component of Aspect 15, wherein an nth section comprises an nth photonic crystal and an nth dye and wherein an (n+1)th section comprises (i) the nth photonic crystal and an (n+1)th dye; (ii) an (n+1)th photonic crystal and the nth dye; or (iii) an (n+1)th photonic crystal and an (n+1)th dye. One such component is provided in FIGS. 1A-1C, which depict a component having different photonic crystal rows, with different dyes present along different columns of the rows. In this way, one can fabricate a multiplexed sensor, and such a sensor can be used to discriminate between different volatile compounds, such as different VOCs.

Aspect 17. The colorimetric component of any one of Aspects 15-16, wherein (i) an nth photonic crystal exhibits a reflectance spectrum having a stopband edge, (ii) an nth dye absorbs light at a characteristic wavelength peak outside the stopband edge when free of contact with the volatile compound, and (iii) when the nth dye is contacted with the volatile compound, the characteristic wavelength peak shifts closer to or within the stopband edge.

Aspect 18. The colorimetric component of any one of Aspects 15-16, wherein (i) an nth photonic crystal exhibits a reflectance spectrum having a stopband edge, (ii) an nth dye absorbs light at a characteristic wavelength peak within the stopband edge when free of contact with the volatile compound, and (iii) when the nth dye is contacted with the volatile compound, the characteristic wavelength peak shifts outside of the stopband edge.

Aspect 19. The colorimetric component of any one of Aspects 15-18, wherein the colorimetric component achieves the characteristic pattern within 2 minutes of contacting the volatile compound. In some embodiments, the component can achieve the characteristic pattern within 1.5 or even within 1 minute of contacting the volatile compound.

Aspect 20. A colorimetric component, comprising: a first section, the first section comprising a first photonic crystal, and the first section comprising a first subsection that comprises a first volatile compound-sensitive dye and a second subsection that comprises a second volatile compound-sensitive dye; and a second section, the second section comprising a second photonic crystal and the second section comprising a first subsection that comprises the first volatile compound-sensitive dye and a second subsection that comprises the second volatile compound-sensitive dye, the first and second sections being arranged such that the colorimetric component exhibits a characteristic pattern when contacted with a volatile compound, the characteristic pattern correlated to at least one of (i) the volatile compound and (ii) a concentration of the volatile compound. Without being bound to any particular theory or embodiments, FIGS. 1A-1C provide a depiction of such a component.

What is claimed:

1. A colorimetric component, comprising:
a first photonic crystal,
the first photonic crystal having a reflectance spectrum having a stopband in the range of visible light; and
a first dye,
the first dye being sensitive to a volatile compound, the volatile compound comprising at least one of a volatile organic compound (VOC) and a volatile sulfur compound (VSC),
the first dye characterized as undergoing a change in molecular structure when contacted to the volatile compound, and
the first photonic crystal and the first dye being selected such that the colorimetric component exhibits a change in visible color when contacted with the volatile compound.

2. The colorimetric component of claim 1, wherein (i) the first photonic crystal exhibits a reflectance spectrum having a stopband edge, (ii) the first dye absorbs light at a characteristic wavelength peak outside the stopband edge when free of contact with the volatile compound, (iii) when the first dye is contacted with the volatile compound, the characteristic wavelength peak shifts closer to or within the stopband edge.

3. The colorimetric component of claim 1, wherein (i) the first photonic crystal exhibits a reflectance spectrum having a stopband edge, (ii) the first dye absorbs light at a characteristic wavelength peak within the stopband edge when free of contact with the volatile compound, and (iii) when the first dye is contacted with the volatile compound, the characteristic wavelength peak shifts outside of the stopband edge.

4. The colorimetric component of claims 1,
wherein the colorimetric component comprises a first section that comprises the first photonic crystal and the first dye, and
wherein the colorimetric component comprises a second section that comprises at least one of (i) a second photonic crystal and (ii) a second dye.

5. The colorimetric component of claim 4, wherein the second section comprises a second photonic crystal, the second photonic crystal differing from the first photonic crystal.

6. The colorimetric component of claim 4, wherein the second section comprises a second dye, the second dye differing from the first dye.

7. The colorimetric component of claim 1, wherein the first photonic crystal comprises a matrix having a periodic arrangement of holes, the holes optionally being substantially monodisperse.

8. The colorimetric component of claim 7, wherein the matrix comprises a polymer.

9. The colorimetric component of any one of claims 7-8, wherein the matrix comprises a plurality of particles in a periodic arrangement, the particles optionally being substantially monodisperse.

10. The colorimetric component of claim 7, wherein the holes have an average diameter in the range of from about 180 nm to about 450 nm.

11. The colorimetric component of claim 1, further comprising at least one of a Brönsted acid, Lewis acid or base, and a salt.

12. The colorimetric component of claim 1, wherein the first dye comprises at least one chemoresponsive dye.

13. A method, comprising contacting a colorimetric component according to claim 1 to a volatile compound.

14. The method of claim 13, further comprising correlating a change in visible color in the colorimetric component to the volatile compound.

15. A colorimetric component, comprising:
n sections,
an nth section of the n sections comprising a combination of a photonic crystal and a dye,
the nth section exhibiting a change in color when contacted with a volatile compound, the volatile compound comprising at least one of a volatile organic compound (VOC) and a volatile sulfur compound (VSC),
the n sections being arranged such that the colorimetric component exhibits a characteristic pattern when contacted with the volatile compound,
the characteristic pattern correlated to at least one of (i) the volatile compound and (ii) a concentration of the volatile compound.

16. The colorimetric component of claim 15, wherein an nth section comprises an nth photonic crystal and an nth dye and wherein an (n+1)th section comprises (i) the nth photonic crystal and an (n+1)th dye: (ii) an (n+1)th photonic crystal and the nth dye; or (iii) an (n+1)th photonic crystal and an (n+1)th dye.

17. The colorimetric component of claim 15, wherein (i) an nth photonic crystal exhibits a reflectance spectrum having a stopband edge, (ii) an nth dye absorbs light at a characteristic wavelength peak outside the stopband edge when free of contact with the volatile compound, and (iii) when the nth dye is contacted with the volatile compound, the characteristic wavelength peak shifts closer to or within the stopband edge.

18. The colorimetric component of claim 15, wherein (i) an nth photonic crystal exhibits a reflectance spectrum having a stopband edge, (ii) an nth dye absorbs light at a characteristic wavelength peak within the stopband edge when free of contact with the volatile compound, and (iii) when the nth dye is contacted with the volatile compound, the characteristic wavelength peak shifts outside of the stopband edge.

19. The colorimetric component of claim 15, wherein the colorimetric component achieves the characteristic pattern within 2 minutes of contacting the volatile compound.

20. A colorimetric component, comprising:
a first section,
the first section comprising a first photonic crystal, and
the first section comprising a first subsection that comprises a first volatile compound-sensitive dye and a second subsection that comprises a second volatile compound-sensitive dye; and
a second section,
the second section comprising a second photonic crystal and
the second section comprising a first subsection that comprises the first volatile compound-sensitive dye and a second subsection that comprises the second volatile compound-sensitive dye,
the first and second sections being arranged such that the colorimetric component exhibits a characteristic pattern when contacted with a volatile compound,
the characteristic pattern correlated to at least one of (i) the volatile compound and (ii) a concentration of the volatile compound.
